(19) United States
(12) Patent Application Publication
(10) Pub. No.: US 2014/0310364 A1
(43) Pub. Date: Oct. 16, 2014

(54) INSTANT MESSAGE SYSTEM AND INSTANT MESSAGE MANAGING METHOD

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventor: PENG WANG, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 14/251,748

(22) Filed: Apr. 14, 2014

(30) Foreign Application Priority Data
Apr. 15, 2013 (CN) 2013101292021

(51) Int. Cl. H04L 12/58

(52) U.S. Cl. CPC H04L 51/04
USPC 709/206

(57) ABSTRACT

An instant message managing method comprises detecting which client terminal used by a user sends messages according to basic information of the client terminal. A terminal managing module marks the client terminal used by a first user to send messages as a first access terminal, marks the client terminal used by a second user to send messages as a second access terminal, and prohibits all other client terminals of the first and second users from receiving messages. The message transmitting module transmits the messages between the first access terminal and the second access terminal.

### FIELD

The present disclosure relates to an instant message system and an instant message managing method.

### BACKGROUND

Instant message (IM) systems are commonly used to communicate between users in an instantaneous manner. A user can choose to log into an instant message system by using a number of different communication terminals (e.g., personal computers, notebooks, smart phones, mobile Internet devices, or other similar devices) at the same time. However, if the user sends messages to other users via one communication terminal while another communication terminal is logged on to the IM system, reply messages sent from the other users may be displayed on both communication terminals, which compromises information security.

Therefore, what is needed is a means to overcome the above-described shortcoming.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a schematic diagram of an embodiment of a first user communicating with a second user via an instant message system in an instant message server.

FIG. 2 is a schematic block diagram of the instant message server including the instant message system of FIG. 1.

FIG. 3 is a flowchart of one embodiment of an instant message method of the instant message system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

Reference will be made to the drawings to describe various embodiments.

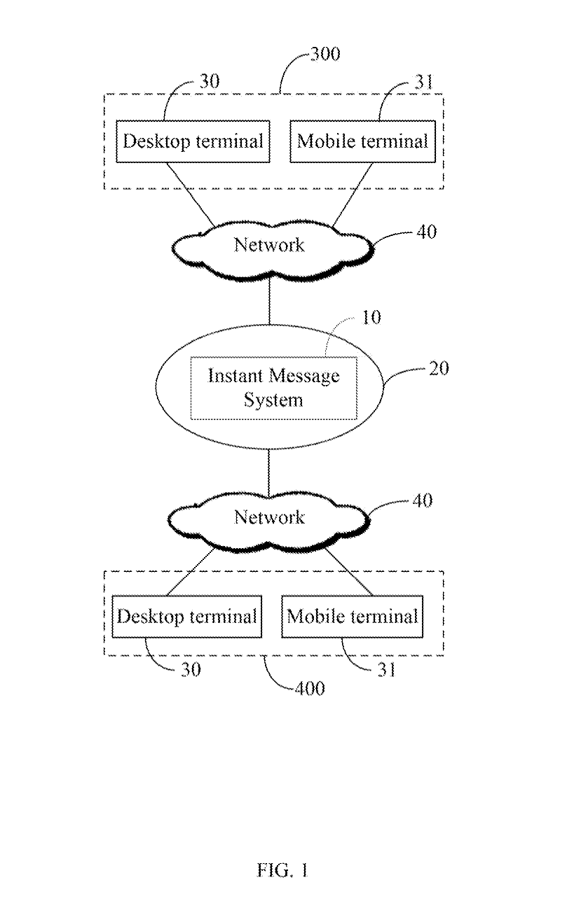

FIG. 1 shows a schematic diagram of an embodiment of a first user 300 and a second user 400 communicating with each other via an instant message system 10. In the embodiment, the instant message system 10 can run on an instant message server 20. The instant message system 10 can be logged onto by different client terminals, such as a desktop terminal 30 and a mobile terminal 31, via a network 40. The desktop terminal 30 can be a personal computer, a notebook, or other similar device. The mobile terminal 31 can be a smart phone, a mobile Internet device (MID), or other similar device. When the first user 300 logs into the instant message system 10 on the desktop terminal 30 or the mobile terminal 31, his/her presence on the instant message system 10 is made known to all authorized partners (commonly termed “buddies”) including the second user 400. The instant message system 10 can be logged into by each of the first user 300 and the second user 400 using different client terminals at the same time. In the embodiment, the first user 300 is defined as an initiator, and the second user 400 is defined as a receiver. The first user 300 can then communicate with the second user 400 via the network 40 and the instant message server 20. In the embodiment, the network 40 can be a wired network or a wireless network. In other embodiments, the instant message system 10 can be downloaded to the desktop terminal 30 or the mobile terminal 31. Thus, the instant message system 10 can be directly run in the desktop terminal 30 or the mobile terminal 31.

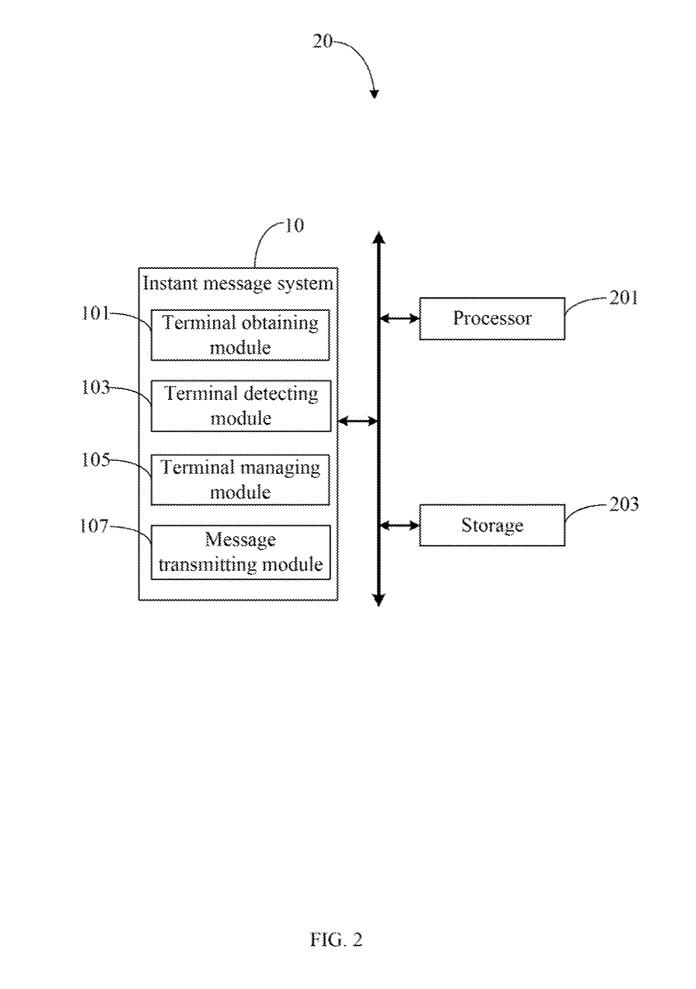

FIG. 2 shows a schematic block diagram of the instant message server 20 including the instant message system 10. The instant message server 20 further includes a processor 201 and a storage 203. FIG. 2 shows only one example of the instant message server 20, and the instant message server 20 can include more or fewer components than those shown in the figure, or have a different configuration of the components.

The instant message system 10 can include a plurality of programs in the form of one or more computerized instructions stored in the storage 203 and executed by the processor 201 to perform operations of the instant message server 20. In one embodiment, the instant message system 10 includes a terminal obtaining module 101, a terminal detecting module 103, a terminal managing module 105, and a message transmitting module 107. In general, the word “module”, as used herein, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The terminal obtaining module 101 obtains basic information of client terminals which are used to log into the instant message system 10 by the first user 300 and the second user 400. In the embodiment, the first user 300 and the second user 400 enter a username and password to log into the instant message system 10. The basic information includes an IP address, an MAC address, and a device identification (ID).

The terminal detecting module 103 detects which client terminal is used by each of the first user 300 and the second user 400 to send messages, according to the basic information of client terminals used by the first user 300 and the second user 400.

The terminal managing module 105 marks a client terminal used by the first user 300 as a first access terminal, marks a client terminal used by the second user 400 as a second access terminal, and prohibits all other client terminals from receiving the messages sent by the instant message system 10.

In detail, the terminal managing module 105 prohibits the other client terminals to receive the messages used by the first user 300 besides the first access terminal, thus the other client terminals could not receive the messages sent by the second user 400. The terminal managing module 105 prohibits the other terminals to receive the messages used by the second user 400 besides the second access terminal, the other client terminals could not receive the messages sent by the first user 300.

Further, when the terminal detecting module 103 detects that the client terminal used by the first user 300 is changed, the terminal managing module 105 re-marks a current client terminal used by the first user 300 as the first access terminal and prohibits the other terminals of the first user 300 from receiving messages sent by the second user 400. When the terminal detecting module 103 detects that the client terminal used by the second user 400 is changed, the terminal managing module 105 re-marks a current client terminal used by the second user 400 as the second access terminal and prohibits the other terminals of the second user 400 from receiving messages sent by the first user 300.

The message transmitting module 107 transmits the messages between the first access terminal and the second access terminal.

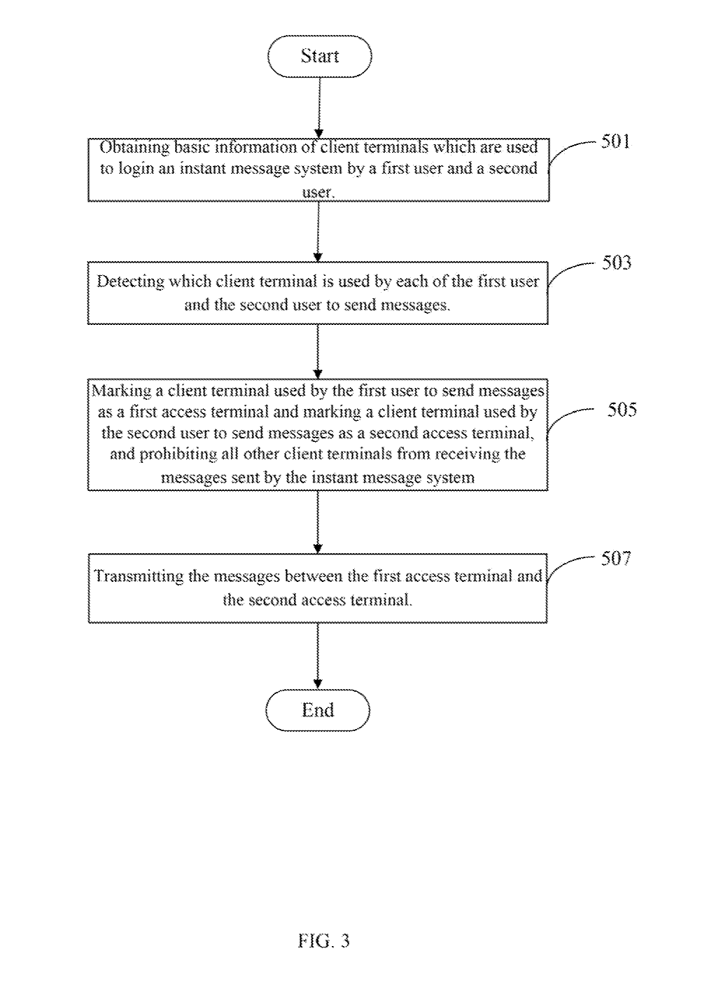

FIG. 3 shows a flowchart of one embodiment of an instant message managing method of the instant message system 10. Depending on the embodiment, additional steps may be added, others removed, and the ordering of the steps may be changed.

In 501, the terminal obtaining module 101 obtains basic information of client terminals which are used to log into the instant message system 10 by the first user 300 and the second user 400. In the embodiment, the first user 300 and the second user 400 enter a username and password to log into the instant message system 10. The basic information includes an IP address, an MAC address, and a device identification (ID).

In 503, the terminal detecting module 103 detects which client terminal is used by each of the first user 300 and the second user 400 to send messages, according to the basic information of client terminals used by the first user 300 and the second user 400.

In 505, the terminal managing module 105 marks a client terminal used by the first user 300 as a first access terminal, marks a client terminal used by the second user 400 as a second access terminal, and prohibits all other client terminals from receiving the messages sent by the instant message system 10.

Further, in 505, when the terminal detecting module 103 detects that the client terminal used by the first user 300 is changed, the terminal managing module 105 re-marks a current client terminal used by the first user 300 as the first access terminal and prohibits the other terminals of the first user 300 from receiving messages sent by the second user 400. When the terminal detecting module 103 detects that the client terminal used by the second user 400 is changed, the terminal managing module 105 re-marks a current client terminal used by the second user 400 as the second access terminal and prohibits the other terminals of the second user 400 from receiving messages sent by the first user 300.

In 507, the message transmitting module 107 transmits the messages between the first access terminal and the second access terminal.

In summary, the instant message system 10 transmits the messages between the first access terminal and the second access terminal, thus, the information security is improved.

It is to be understood that even though numerous characteristics and advantages of the present embodiments have been set forth in the foregoing description, with details of the structures and functions of the embodiments, the disclosure is illustrative only; and changes may be in detail, especially in the matters of arrangement of parts within the principles of the embodiments to the full extent indicated by the broad general meaning of the terms in which the appended claims are expressed.

What is claimed is:

1. An electronic device, comprising:
a processor;
a storage; and
an instant message system comprising one or more programs stored in the storage and executed by the processor, the one or more programs comprising:
a terminal obtaining module obtaining basic information of client terminals which are used to log into the instant message system by a first user and a second user, the first user and the second user communicating with each other using the instant message system;
a terminal detecting module detecting which client terminal is used by each of the first user and the second user to send messages;
a terminal managing module marking a client terminal used by the first user as a first access terminal and marking a client terminal used by the second user as a second access terminal, and prohibiting all other client terminals from receiving the messages sent by the instant message system; and
a message transmitting module transmitting the messages between the first access terminal and the second access terminal.

2. The electronic device of claim 1, wherein the instant message system can be logged into by each of the first and second users using different client terminals at the same time.

3. The electronic device of claim 1, wherein the basic information comprises an IP address, an MAC address, and a device identification (ID) of each of the client terminals.

4. The electronic device of claim 1, wherein the terminal detecting module detects which client terminal is used by each of the first user and the second user to send messages, according to the basic information of client terminals used by the first user and the second user.

5. The electronic device of claim 1, wherein the terminal managing module prohibits the other client terminals used by the first user to login the instant message system besides the first access terminal to receive the messages sent by the second user via the instant message system.

6. The electronic device of claim 1, wherein the terminal managing module prohibits the other client terminals used by the second user to login the instant message system besides the second access terminal to receive the messages sent by the first user via the instant message system.

7. The electronic device of claim 5, wherein when the client terminal that is used by the first user to send the messages is changed, the terminal managing module re-marks a current client terminal used by the first user as the first access terminal and prohibits the other terminals of the first user from receiving messages sent by the second user.

8. The electronic device of claim 6, wherein when the client terminal that is used by the second user to send the messages is changed, the terminal managing module re-marks a current client terminal used by the second user as the second access terminal and prohibits the other terminals of the second user from receiving messages sent by the first user.

9. An instant message managing method of an instant message system executed by an electronic device, comprising:
obtaining basic information of client terminals which are used to log into the instant message system by a first user and a second user, the first user and the second user communicating with each other using the instant message system;
detecting which client terminal is used by each of the first user and the second user to send messages;
marking a client terminal used by the first user as a first access terminal and marking a client terminal used by the second user as a second access terminal, and prohibiting all other client terminals from receiving the messages sent by the instant message system; and
transmitting the messages between the first access terminal and the second access terminal.

10. The instant message managing method of claim 9, wherein the instant message system can be logged into by each of the first and second users using different client terminals at the same time.

11. The instant message managing method of claim 9, wherein the basic information comprises an IP address, an MAC address, and a device identification (ID) of each of the client terminals.

12. The instant message managing method of claim 9, wherein the client terminal that is used by each of the first user and the second user to send messages, according to the basic information of client terminals used by the first user and the second user.

13. The instant message managing method of claim 9, wherein the other client terminals used by the first user to login the instant message system besides the first access terminal are prohibited to receive the messages sent by the second user via the instant message system.

14. The instant message managing method of claim 9, wherein the other client terminals used by the second user to login the instant message system besides the second access terminal are prohibited to receive the messages sent by the first user via the instant message system.

15. The instant message managing method of claim 9, further comprising:
re-marking a current client terminal used by the first user to send the messages as the first access terminal when the client terminal used by the first user to send the messages is changed and prohibiting the other client terminals of the first user from receiving messages sent by the second user.

16. The instant message managing method of claim 9, further comprising:
re-marking a current client terminal used by the second user to send the messages as the second access terminal when the client terminal used by the second user to send the messages is changed and prohibiting the other client terminals of the second user from receiving messages sent by the first user.
